(19) United States
(12) Patent Application Publication
(10) Pub. No.: US 2026/0267572 A1
(43) Pub. Date: Sep. 10, 2026

(54) INFORMATION PROCESSING SYSTEM AND NON-TRANSITORY COMPUTER READABLE MEDIUM

(71) Applicant: FUJIFILM Business Innovation Corp., Kanagawa (JP)

(72) Inventor: Misaki MATSUZAWA, Kanagawa (JP)

(73) Assignee: FUJIFILM Business Innovation Corp., Kanagawa (JP)

(21) Appl. No.: 19/309,719

(22) Filed: Aug. 26, 2025

(30) Foreign Application Priority Data
Mar. 4, 2025 (JP) 2025-033817

(51) Int. Cl. G06F 3/12

(52) U.S. Cl. CPC G06F 3/1225; G06F 3/1204; G06F 3/1288

(57) ABSTRACT

An information processing system includes a processor configured to: store, as first information, information on a printer driver uploaded from a user terminal logging out from a server configured to manage a group policy; acquire, as second information, information on a printer driver uploaded from the user terminal logging into the server; and collate the first information with the second information and control distribution of a printer driver conforming to Windows Protected Print Mode to the user terminal.

### CROSS-REFERENCE TO RELATED APPLICATIONS

This application is based on and claims priority under 35 USC 119 from Japanese Patent Application No. 2025-033817 filed Mar. 4, 2025.

### BACKGROUND

### Technical Field

The present disclosure relates to an information processing system and a non-transitory computer readable medium.

### Related Art

With the aim of enhancing the security of printing systems, Microsoft Corporation has released Windows (registered trademark) Protected Print Mode (WPP).

Examples of the related art include Japanese Unexamined Patent Application Publication No. 2006-048229.

### SUMMARY

When Windows Protected Print Mode is activated on a server that sets a group policy, at the point when a user logs into the server, a third-party printer driver is deleted from a user terminal used for the login. As a result, printing using the third-party printer driver is disabled. However, a user who is not aware of the activation of Windows Protected Print Mode may be confused by the fact that he/she cannot perform printing in a conventional manner.

Aspects of non-limiting embodiments of the present disclosure relate to improving the convenience of printing compared with a case without a service supporting the introduction of Windows Protected Print Mode.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including a processor configured to: store, as first information, information on a printer driver uploaded from a user terminal logging out from a server configured to manage a group policy; acquire, as second information, information on a printer driver uploaded from the user terminal logging into the server; and collate the first information with the second information and control distribution of a printer driver conforming to Windows Protected Print Mode to the user terminal.

### BRIEF DESCRIPTION OF THE DRAWINGS

Exemplary embodiments of the present disclosure will be described in detail based on the following figures, wherein:

FIG. 1 is a diagram illustrating an exemplary configuration of a group policy management system;

FIG. 2 is a diagram illustrating an example of a hardware configuration of a policy management server;

FIG. 3 is a diagram illustrating an example of a hardware configuration of a WPP introduction support server;

FIG. 4 is a diagram illustrating an example of a hardware configuration of a user terminal;

FIG. 5 is a diagram illustrating a processing sequence executed when the user terminal logs out from the policy management server;

FIG. 6 is a diagram illustrating an example of a folder storing registry information on a printer driver;

FIG. 7 is a diagram illustrating an example of a print setting screen linked with an icon of a printer;

FIG. 8 is a diagram illustrating an example of a module managed by a Spool folder;

FIG. 9 is a diagram illustrating a processing sequence executed when the user terminal logs into the policy management server;

FIG. 10 is a diagram illustrating a processing sequence executed after an affirmative result is obtained in step 212 (see FIG. 9);

FIG. 11 is a diagram illustrating a display example of a message;

FIG. 12 is a diagram illustrating an example of a hardware configuration of the WPP introduction support server;

FIG. 13 is a diagram illustrating another processing sequence executed after an affirmative result is obtained in step 212 (see FIG. 9);

FIG. 14 is a diagram illustrating a display example of a message for notification of an inapplicable setting;

FIG. 15 is a diagram illustrating an example of a hardware configuration of the policy management server; and

FIG. 16 is a diagram illustrating an example of a distribution sequence for an upload program for printer driver information.

### DETAILED DESCRIPTION

Hereinafter, exemplary embodiments of the present disclosure will be described with reference to the drawings.

### Terms

The "Windows Protected Print Mode" or "WPP" is one of the setting functions available with Windows 11, version 24H2 or later. The WPP is a technique intended to improve printing security. With a computer with which the WPP setting is activated, reading of a third-party printer driver is restricted. Furthermore, an installed third-party printer driver is forcibly deleted from the computer.

When the WPP setting activated is deactivated, a printer driver deleted would not be automatically restored in the computer. Thus, the user wishing to restore the printing environment before the WPP setting is activated needs to individually reinstall, in the computer, the third-party printer driver deleted by the WPP. As long as the WPP setting is active, a reinstalled third-party printer driver is automatically deleted in response to relogin.

A "printer driver supporting Internet Printing Protocol (IPP)" is a printer driver that can cause a printer at a remote location to perform printing through the Internet. Once the WPP setting is activated, printing can only be performed with the IPP supporting printer driver. Thus, the IPP supporting printer driver is an example of the printer driver conforming to WPP.

The "group policy" is a function of centrally managing information in an organization using Windows. Settings managed by the group policy are applied to a computer in the active directory environment. The information to be centrally managed also includes the print setting of the computer. The group policy is applied when the computer is started.

The "active directory" is a directory service for centrally managing resources in an organization. The active directory is one of the functions installed in the Windows server.

### FIRST EXEMPLARY EMBODIMENT

### Configuration of Group Policy Management System

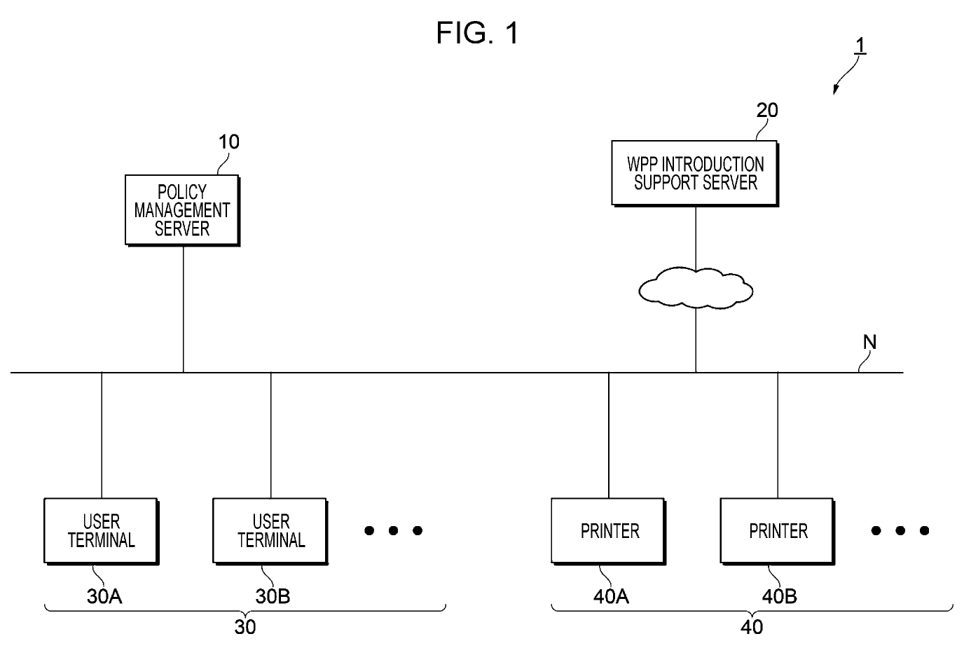

FIG. 1 is a diagram illustrating an exemplary configuration of a group policy management system 1.

The group policy management system 1 illustrated in FIG. 1 includes a policy management server 10, a WPP introduction support server 20, user terminals 30 (30A, 30B), and printers 40 (40A, 40B).

The policy management server 10, the WPP introduction support server 20, the user terminals 30, and the printers 40 are all terminals connected to a network N.

The policy management server 10 is a server that manages the application of the group policy to the user terminals 30 (30A, 30B) and users. Specifically, the policy management server 10 is a computer terminal that remotely activates the WPP setting in the user terminals 30 to be managed.

The user terminals 30 (30A, 30B) are terminals operated by users who use the printers 40 (40A, 40B).

In the present exemplary embodiment, the user terminals 30 (30A and 30B) use the printers 40 by using a printer driver manufactured by a third party (for example, the manufacturer of the printers 40) until the WPP setting is activated. Once the WPP setting is activated, all third-party printer drivers and related information are uninstalled at the point when the user terminals 30 start.

The WPP introduction support server 20 is a server that provides a service for recovering an impact on a third-party printer driver imposed as a result of the WPP setting activation. More specifically, the WPP introduction support server 20 provides a service for storing the print setting and the like of the third-party printer driver installed in the user terminals 30 before the WPP setting is activated in the user terminals 30. Further, the WPP introduction support server 20 provides a service for notifying the user terminals 30 of the print setting and the like of the third-party printer driver.

In FIG. 1, the policy management server 10, the user terminals 30, and the printers 40 are connected to, for example, the same network N, and the WPP introduction support server 20 is connected to the policy management server 10 and the like through the Internet. The WPP introduction support server 20 may also be connected to the same network as the policy management server 10 and the like.

The network N may be, for example, a local area network (LAN), the Internet (including an intranet), or a mobile communication system based on 4G, 5G, or the like. The network N may be a wired network, a wireless network, or a combined network thereof.

While one policy management server 10 and one WPP introduction support server 20 are illustrated in FIG. 1, there may be a plurality of policy management servers 10 and a plurality of WPP introduction support servers 20.

The operator of the policy management server 10 and the operator of the WPP introduction support server 20 may be the same or different from each other.

While two user terminals 30 and two printers 40 are illustrated in FIG. 1, there may be one user terminal 30 and one printer 40 or three or more user terminals 30 and three or more printers 40.

### Hardware Configurations of Terminal

### Hardware Configuration of Policy Management Server

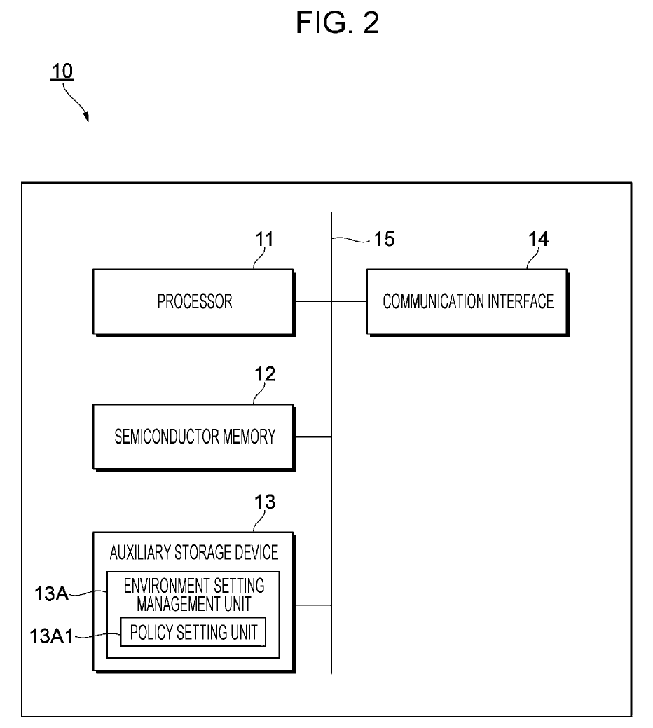

FIG. 2 is a diagram illustrating an example of a hardware configuration of the policy management server 10.

The policy management server 10 illustrated in FIG. 2 includes a processor 11, a semiconductor memory 12, an auxiliary storage device 13, and a communication interface 14. These devices are connected to each other through a bus or another signal line 15.

The processor 11 is a device that implements various functions by executing a program.

The semiconductor memory 12 may include, for example, a read only memory (ROM) storing a unified extensible firmware interface (UEFI) or the like, and a random access memory (RAM) used as a work area for the processor 11.

The processor 11 and the semiconductor memory 12 function as what is known as a computer.

The auxiliary storage device 13 includes, for example, a hard disk drive or a semiconductor storage. The auxiliary storage device 13 stores programs and various types of data. The term program is used as a generic term for an operating system (OS) and an application program.

The auxiliary storage device 13 stores an environment setting management unit 13A as one of the programs.

The environment setting management unit 13A is a program for managing environment settings, such as a group policy, of the user terminals 30. The environment setting management unit 13A includes a policy setting unit 13A1 as a subprogram. The policy setting unit 13A1 holds setting information such as an application timing of a group policy to be applied to the user terminals 30.

The communication interface 14 is an interface for communicating with the user terminals 30 through the network N. The communication interface 14 supports various communication standards. Examples of such communication standards include Ethernet (registered trademark), Wi-Fi (registered trademark), and a mobile communication system.

### Hardware Configuration of WPP Introduction Support Server

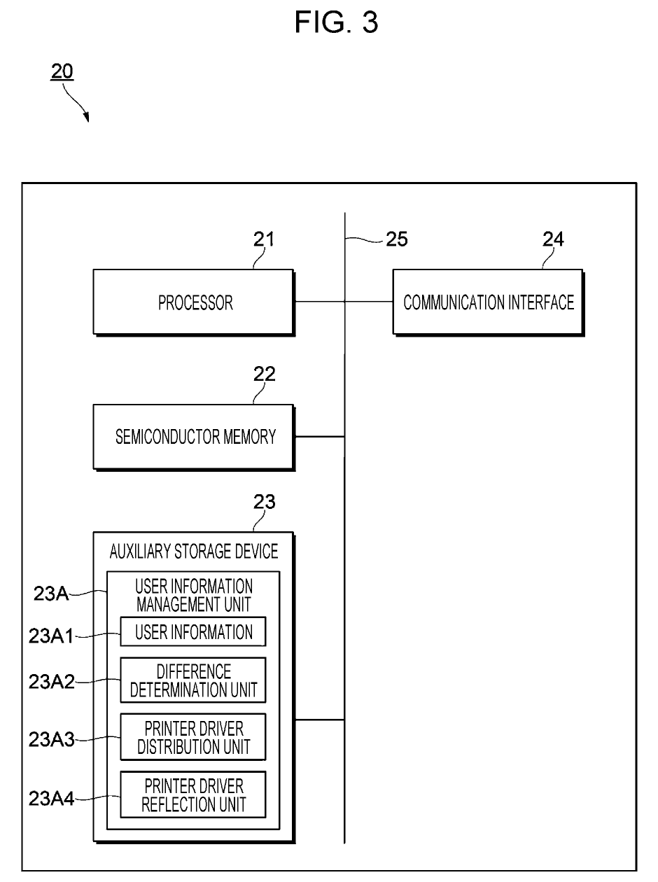

FIG. 3 is a diagram illustrating an example of a hardware configuration of the WPP introduction support server 20.

The WPP introduction support server 20 illustrated in FIG. 3 includes a processor 21, a semiconductor memory 22, an auxiliary storage device 23, and a communication interface 24. These devices are connected to each other through a bus or another signal line 25.

The processor 21 is a device that implements various functions by executing programs.

The semiconductor memory 22 may include, for example, a ROM storing a UEFI or the like, and a RAM used as a work area for the processor 21.

The processor 21 and the semiconductor memory 22 function as what is known as a computer.

The auxiliary storage device 23 includes, for example, a hard disk drive or a semiconductor storage. The auxiliary storage device 23 stores programs and various types of data.

The auxiliary storage device 23 stores a user information management unit 23A as one of the programs.

The user information management unit 23A is a program that executes, for each of the user terminals 30 (for example, user accounts), storage of a printer driver usage status, determination of a difference between printer drivers, and distribution of printer drivers.

The user information management unit 23A includes user information 23A1, a difference determination unit 23A2, a printer driver distribution unit 23A3, and a printer driver reflection unit 23A4.

The user information 23A1 is registry information or module information on a printer driver that is stored at the timing of logout of each of the user terminals 30. The registry information includes standard settings of the printer driver and setting information on each icon. The module information includes a module for generating a print job and a module for displaying a user interface.

The difference determination unit 23A2 is a program for analyzing whether there is a difference between the registry information or the module information on the printer driver at the timing of login and the registry information or the module information on the printer driver stored at the timing of the previous logout.

The printer driver distribution unit 23A3 is a program for distributing the IPP supporting printer driver to the user terminals 30 when the difference determination unit 23A2 detects a difference in the registry information or the module information.

The printer driver reflection unit 23A4 is a program for reflecting the difference in the print setting (for example, the print setting on a third-party printer driver) in the IPP supporting printer driver, after the distribution of the IPP supporting printer driver.

The communication interface 24 is an interface for communicating with the user terminals 30 through the network N. The communication interface 24 supports various communication standards. Examples of such communication standards include Ethernet (registered trademark), Wi-Fi (registered trademark), and a mobile communication system.

### Hardware Configuration of User Terminal

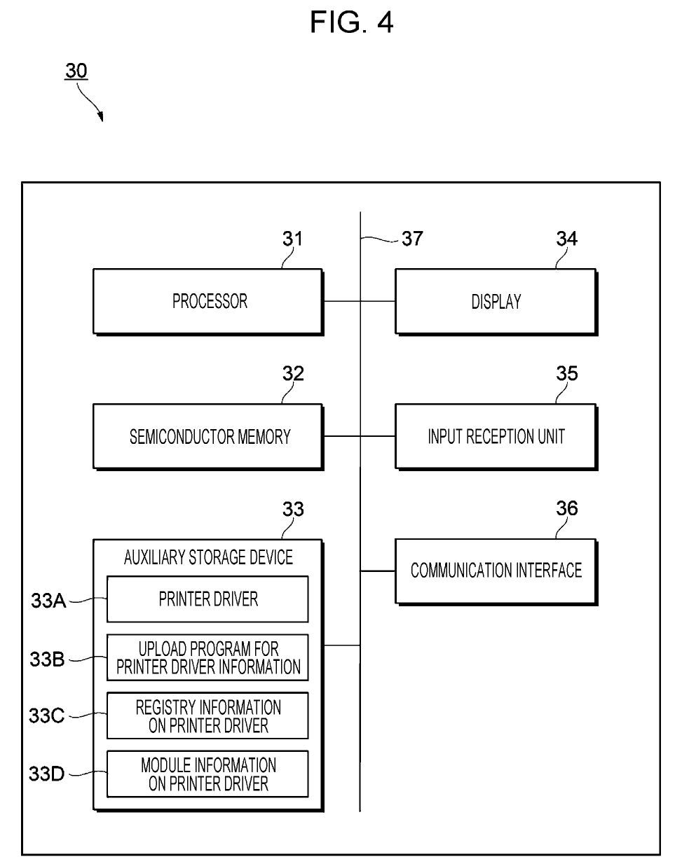

FIG. 4 is a diagram illustrating an example of a hardware configuration of the user terminal 30.

The user terminal 30 illustrated in FIG. 4 includes a processor 31, a semiconductor memory 32, an auxiliary storage device 33, a display 34, an input reception unit 35, and a communication interface 36. These devices are connected to each other through a bus or another signal line 37.

The processor 31 is a device that implements various functions by executing programs.

The semiconductor memory 32 may include, for example, a ROM storing a UEFI or the like, and a RAM used as a work area for the processor 31.

The processor 31 and the semiconductor memory 32 function as what is known as a computer.

The auxiliary storage device 33 includes, for example, a hard disk drive or a semiconductor storage. The auxiliary storage device 33 stores programs and various types of data.

The auxiliary storage device 33 stores a printer driver 33A serving as one of the programs and an upload program 33B for printer driver information. In addition, the auxiliary storage device 33 also stores information on the printer driver 33A (that is, registry information 33C on the printer driver and module information 33D on the printer driver).

The printer driver 33A is a program for transmitting a print job to the printers 40 (see FIG. 1). The print job is data for issuing an instruction to execute print data. The print data is provided as, for example, page description language (PDL) data or bitmap data. The PDL data is described in a vector format. On the other hand, the bitmap data is described in units of pixels.

The upload program 33B for printer driver information is a program for uploading information on the printer driver 33A (the registry information 33C on the printer driver and the module information 33D on the printer driver) to the WPP introduction support server 20 (see FIG. 1).

The upload program 33B for printer driver information has the function of monitoring a logout from the policy management server 10 (see FIG. 1).

When a logout from the policy management server 10 (see FIG. 1) is detected, the upload program 33B for printer driver information uploads the information on the printer driver 33A to the WPP introduction support server 20.

The registry information 33C on the printer driver includes standard settings on the printer driver 33A and the setting information for each icon.

The module information 33D on the printer driver includes a module for generating a print job and a module for displaying a user interface.

As the display 34, for example, a liquid crystal display or an organic electroluminescence (EL) display is used.

The input reception unit 35 is a functional unit that receives an input from, for example, a keyboard, a mouse, or other input devices.

The communication interface 36 is an interface for communicating with the policy management server 10 and the WPP introduction support server 20 through the network N. The communication interface 36 supports various communication standards. Examples of such communication standards include Ethernet (registered trademark), Wi-Fi (registered trademark), and a mobile communication system.

### Hardware Configuration of Printer

The printer 40 (see FIG. 1) includes a processor, a ROM, a RAM used as a work area for the processor, an auxiliary storage device, an image processing unit, a printing unit, and a communication interface. These devices are connected to each other through a bus or another signal line. In addition, the printer 40 is also provided with a mechanism for storing sheets and a mechanism for conveying sheets.

The processor controls the operation of each device through execution of programs including an OS and firmware, and outputs a printed material corresponding to print data.

The auxiliary storage device includes, for example, a hard disk drive or a semiconductor storage. The auxiliary storage device stores print data received from the user terminal 30 (see FIG. 1).

Upon receiving the print data in the form of PDL data, the image processing unit converts the PDL data into bitmap data. This process is referred to as a rasterizing process. The printing unit is a mechanical unit that forms an image on a sheet by, for example, an electrophotographic method or an inkjet method.

The communication interface is used for communication with the user terminal 30 (see FIG. 1).

### Processing Sequence

### Processing Sequence at Timing of Logout

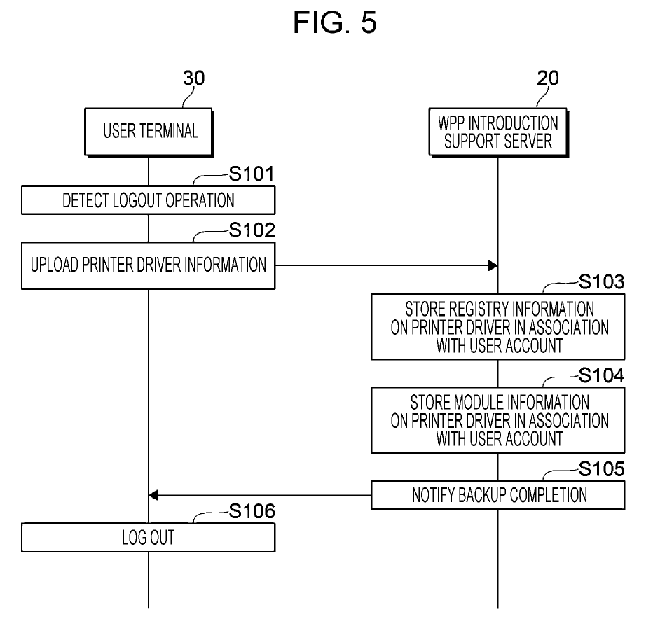

FIG. 5 is a diagram illustrating a processing sequence at the timing when the user terminal 30 logs out from the policy management server 10 (see FIG. 1). The symbol S illustrated in the figure represents a step.

In the user terminal 30, the upload program 33B for printer driver information (see FIG. 4) is operating in the background.

When the upload program 33B for the printer driver information detects a logout operation (step 101), the user terminal 30 uploads the printer driver information (step 102).

The IP address of the WPP introduction support server 20, which is the upload destination, is stored in the upload program 33B for printer driver information. The information on the printer driver is an example of first information.

The WPP introduction support server 20 stores the registry information on the printer driver in association with the user account (step 103). The registry information on the printer driver includes, for example, the print setting and authentication information unique to each user who operates the user terminal 30 (see FIG. 1).

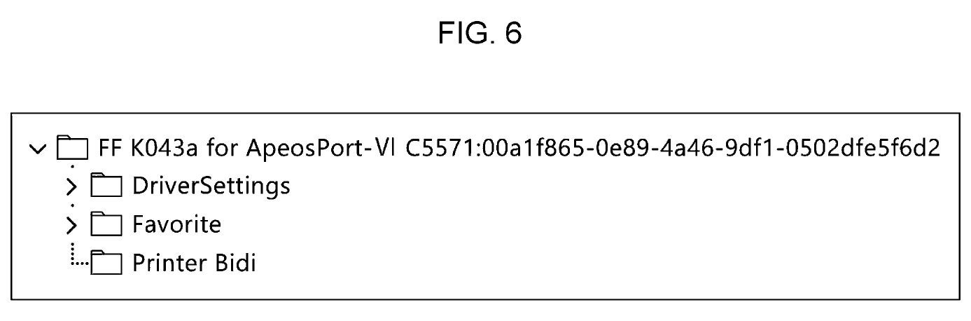

FIG. 6 is a diagram illustrating an example of a folder storing the registry information on the printer driver. In FIG. 6, the model name of the printer 40 is "FF K043a for ApeosPort-VI C5571". Corresponding registers are stored in three folders "DriverSetttings", "Favorite", and "Printer Bidi".

The description is given referring back to FIG. 5.

Next, the WPP introduction support server 20 stores the module information on the printer driver in association with the user account (step 104). The module information on the printer driver is what is known as driver information and is managed in association with an icon of the printer 40 in which the printer driver is installed. The module information on the printer driver is stored in, for example, a "Driver Store" folder and a "Spool" folder.

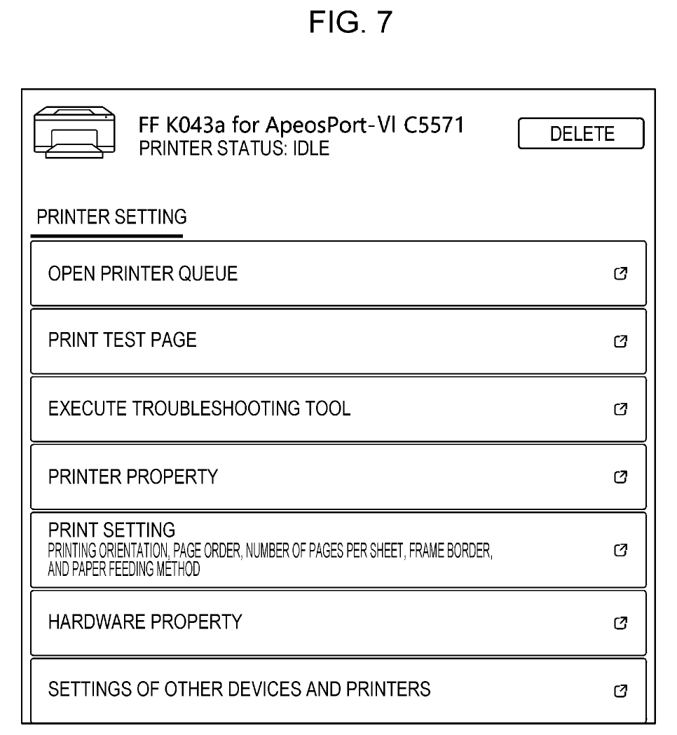

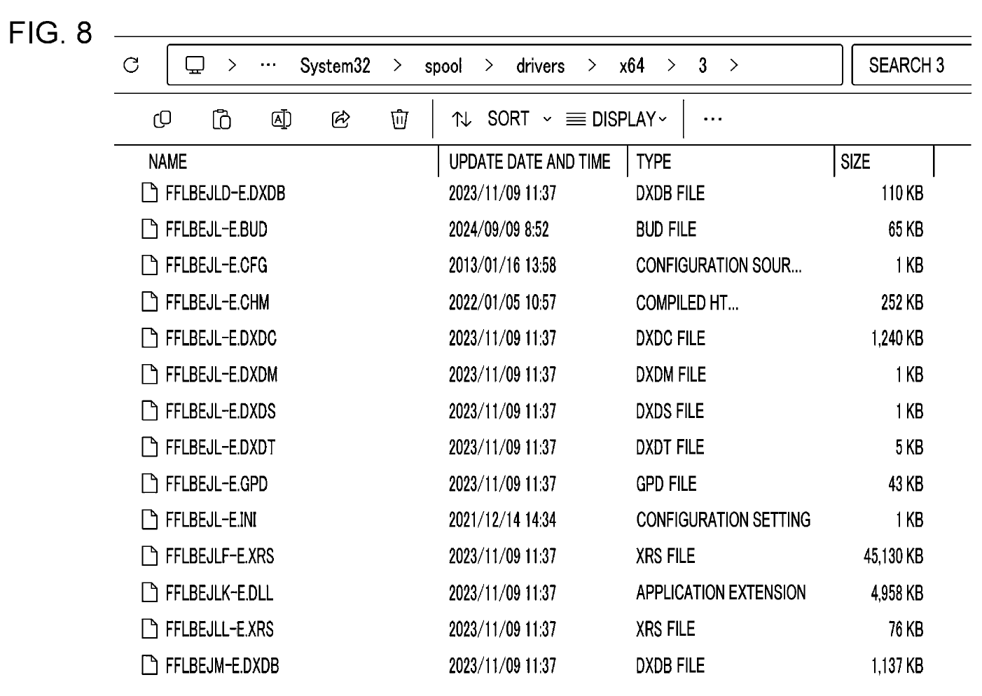

FIG. 7 is a diagram illustrating an example of a print setting screen associated with an icon of the printer 40. In FIG. 7, the model name of the printer 40 used by the user terminal 30 is "FF K043a for ApeosPort-VI C5571". FIG. 8 is a diagram illustrating an example of a module managed with the Spool folder.

The description is given referring back to FIG. 5.

When the storage of the registry information and the module information on the printer driver is completed, the WPP introduction support server 20 notifies the user terminal 30 of the completion of backup (step 105).

When the user terminal 30 receives the backup completion notification, the user terminal 30 logs out from the policy management server 10 (step 106).

The above processing operations are executed by the number of times corresponding to the number of models of the printers 40 installed in the user terminal 30.

### Processing Sequence at Login Timing

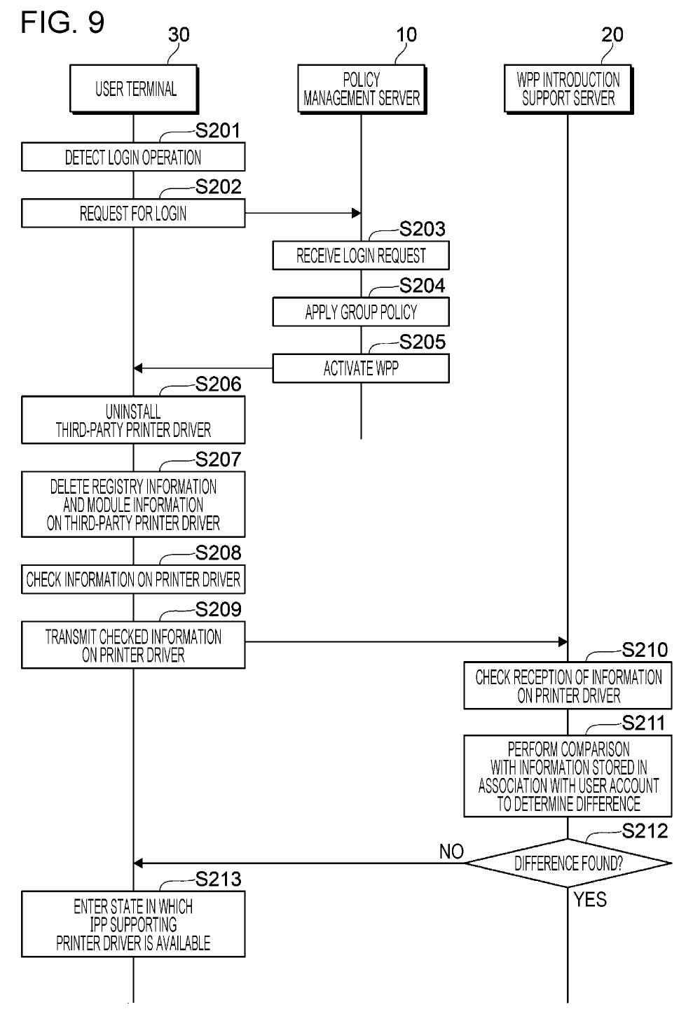

FIG. 9 is a diagram illustrating a processing sequence at the timing when the user terminal 30 logs into the policy management server 10 (see FIG. 1).

Also in this case, in the user terminal 30, the upload program 33B for printer driver information (see FIG. 4) is operating in the background.

When the upload program 33B for printer driver information detects a login operation (step 201), the user terminal 30 requests the policy management server 10 for login (step 202).

When the policy management server 10 receives the login request from the user terminal 30 (step 203), the policy management server 10 applies a group policy (step 204). In the present exemplary embodiment, activation of a WPP setting is registered as the group policy. Thus, the policy management server 10 activates the WPP of the user terminal 30 (step 205).

The user terminal 30 with the WPP activated uninstalls a third-party printer driver (step 206). Of course, if no third-party printer driver is installed, the uninstallation in step 206 is not executed.

The user terminal 30 deletes the registry information and the module information on the third-party printer driver (step 207). Of course, when no third-party printer driver is installed, the deletion in step 207 is not executed.

When the WPP setting is activated in the user terminal 30 with a third-party printer driver installed, steps 206 and 207 are executed, and printing using the third-party printer driver is disabled.

These processes are executed in the background. Thus, the user is unaware of uninstallation or the like of the third-party printer driver or related information from the user terminal 30 operated by the user.

Then, the user terminal 30 checks information on the printer driver installed in the user terminal 30 (step 208), and transmits the checked information on the printer driver to the WPP introduction support server 20 (step 209). Of course, this upload is executed by the upload program 33B for printer driver information. The information on the printer driver is an example of second information.

On the other hand, the WPP introduction support server 20 checks the reception of the information on the printer driver (step 210).

Next, the WPP introduction support server 20 performs comparison with information stored in association with the user account to determine a difference (step 211). Specifically, whether there is a difference between information (for example, registries and modules) on the printer driver stored at the timing of the previous logout and information on the printer driver at the timing of the current login is determined. With this determination, the presence or absence of the difference and the details of the difference are determined.

Then, the WPP introduction support server 20 determines whether there is a difference (step 212).

When there is no difference, a negative result is obtained in step 212. No difference means that the information on the printer driver stored at the timing of the previous logout matches the information on the printer driver notified at the timing of the current login.

For example, when the setting of the WPP is not active, a negative result is obtained in step 212. When the WPP setting was already active at the point of the previous logout, a negative result is obtained in step 212.

In this case, the user terminal 30 is notified of such a fact. Upon receiving the notification, the user terminal 30 enters a state in which an IPP supporting printer driver is available (step 213).

On the other hand, when there is a difference, an affirmative result is obtained in step 212. When there is a difference, it means that the information on the printer driver stored at the timing of the previous logout does not match the information on the printer driver notified at the timing of the current login.

For example, when information on a third-party printer driver is stored in the WPP introduction support server 20 at the timing of the previous logout, an affirmative result is obtained in step 212.

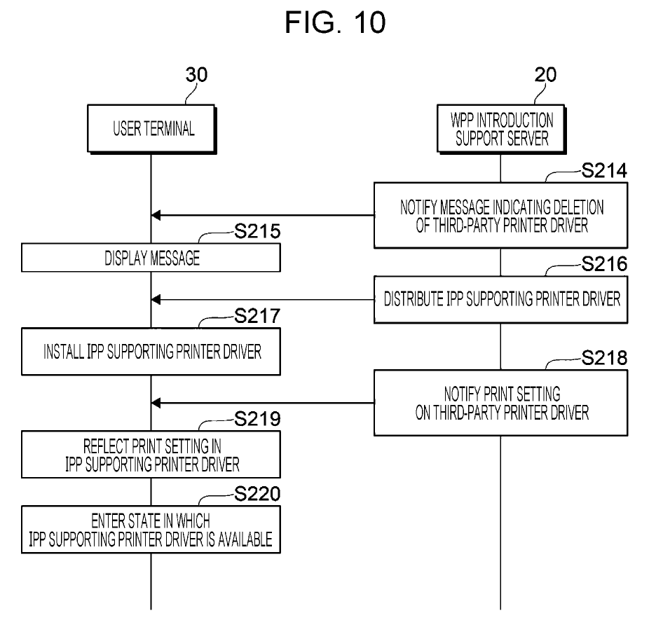

In this case, the WPP introduction support server 20 proceeds to step 214 (see FIG. 10).

FIG. 10 is a diagram illustrating a processing sequence executed after an affirmative result is obtained in step 212 (see FIG. 9).

Upon detecting the difference in the information on the printer driver, the WPP introduction support server 20 notifies the user terminal 30 of a message indicating deletion of the third-party printer driver (step 214).

Upon receiving the notification, the user terminal 30 displays a message (step 215).

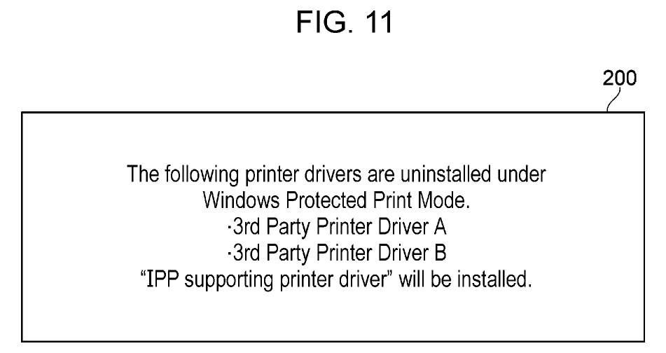

FIG. 11 is a diagram illustrating a display example of a message 200. The message 200 illustrated in FIG. 11 indicates that two printer drivers have been uninstalled under the WPP mode and that an IPP supporting printer driver is to be installed. With this notification, the user can be made aware that the third-party printer drivers that have been used have been deleted. However, an operation without the execution of such a notification is also possible.

The description is given referring back to FIG. 10.

Next, the WPP introduction support server 20 distributes the IPP supporting printer driver to the user terminal 30 (step 216).

The user terminal 30 installs the IPP supporting printer driver (step 217). With the installation of the printer driver, a situation where printing with the printer 40 (see FIG. 1) as an output destination is disabled is avoided.

Next, the WPP introduction support server 20 notifies the user terminal 30 of the print setting on the third-party printer driver (step 218). The notified print setting information is the registry information and the module information on the printer driver stored in steps 103 and 104 (see FIG. 5).

The user terminal 30 reflects the print setting in the IPP supporting printer driver (step 219). For example, the print setting and the authentication information are written in the registry of the IPP supporting printer driver.

Once the reflection is completed, the user terminal 30 enters a state in which the IPP supporting printer driver is available (step 220). Even without resetting the print setting and the authentication information used by the third-party printer driver in the IPP supporting printer driver, the user can use the printer 40 with the same setting as that before the WPP setting is activated.

When the user logs out from the policy management server 10 (see FIG. 1), the processing sequence illustrated in FIG. 5 is executed.

### Summary

With the above-described group policy management system 1 (see FIG. 1), the user can continue to use the printer 40 (see FIG. 1) even in an environment where the WPP setting is activated by the group policy.

When there is no mechanism described above, third-party printer drivers are only automatically uninstalled from the user terminal 30 in response to the activation of the WPP setting by the group policy. In other words, the IPP supporting printer driver is not automatically installed. This means that the user is unable to use the printer 40 until the IPP supporting printer driver is newly installed in the user terminal 30.

Furthermore, with the above-described group policy management system 1 (see FIG. 1), installation of an IPP supporting printer driver is notified in steps 214 and 215 (see FIG. 10). Therefore, unlike a situation where the mechanism described above is absent, the user can recognize in advance that the IPP supporting printer driver will be newly installed.

With this configuration, even when the print setting screen layout or the like is changed, the user will not be surprised.

With the above-described group policy management system 1 (see FIG. 1), information on a third-party printer driver can be automatically maintained in an IPP supporting printer driver. Thus, the user does not need to individually re-register print setting and authentication information. Thus, even when the WPP setting is activated by the group policy, no work load is imposed on the user or the like who operates the user terminal 30.

### SECOND EXEMPLARY EMBODIMENT

### Background

As described above, the WPP introduction support server 20 (see FIG. 1) has a function of reflecting the information on the printer driver stored at the timing of the previous logout, in the IPP supporting printer driver to be newly installed.

However, information from a third-party printer driver may not be maintained in an IPP supporting printer driver.

An example of such a case is that when a third-party printer driver has two setting options for a stapling function, "AVAILABLE" and "NOT AVAILABLE", an IPP supporting printer driver can designate the number of stapling positions as its stapling function. For example, when one, two, or four positions can be set with the IPP supporting printer driver, the destination for which the setting "AVAILABLE" for the stapling function in the third-party printer driver is maintained is not uniquely determined.

In the present exemplary embodiment, a description will be given of a technology capable of addressing a technical problem that arises when information on a printer driver is reflected.

### Configuration of Group Policy Management System

Also in the present exemplary embodiment, the group policy management system 1 (see FIG. 1) is assumed.

### Hardware Configuration of Terminal

In the present exemplary embodiment, the hardware configuration of the WPP introduction support server 20 (see FIG. 1) is changed.

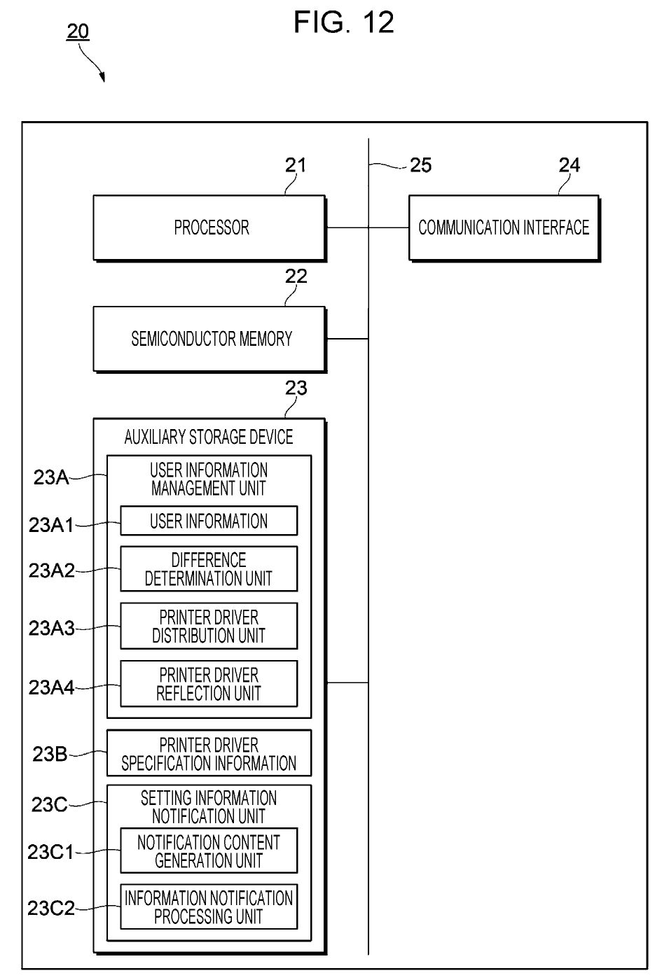

FIG. 12 is a diagram illustrating an example of a hardware configuration of the WPP introduction support server 20. In FIG. 12, parts corresponding to those in FIG. 3 are denoted by the same reference numerals.

In the case of the WPP introduction support server 20 illustrated in FIG. 12, printer driver specification information 23B and a setting information notification unit 23C are added to the auxiliary storage device 23.

The latest specifications of a third-party printer driver are stored in the printer driver specification information 23B. The specifications include, for example, information on registries and modules. The specifications may be acquired from, for example, the official website of a company that provides the third-party printer driver.

The setting information notification unit 23C is a program that notifies the user terminals 30 (see FIG. 1) of the difference detected by the difference determination unit 23A2 using a message.

The setting information notification unit 23C includes a notification content generation unit 23C1 and an information notification processing unit 23C2.

The notification content generation unit 23C1 is a program that generates a message for notifying the user terminals 30 of the processing result of the user information management unit 23A.

The information notification processing unit 23C2 is a program that notifies the user terminals 30 of the message generated by the notification content generation unit 23C1.

### Processing Sequence

Also in the present exemplary embodiment, the processing sequence at the timing of logout is the same as that in the first exemplary embodiment. However, the processing sequence at the timing of login in the present exemplary embodiment is partially different from that in the first exemplary embodiment. Specifically, an additional processing sequence is provided after an affirmative result is obtained in step 212 (see FIG. 9).

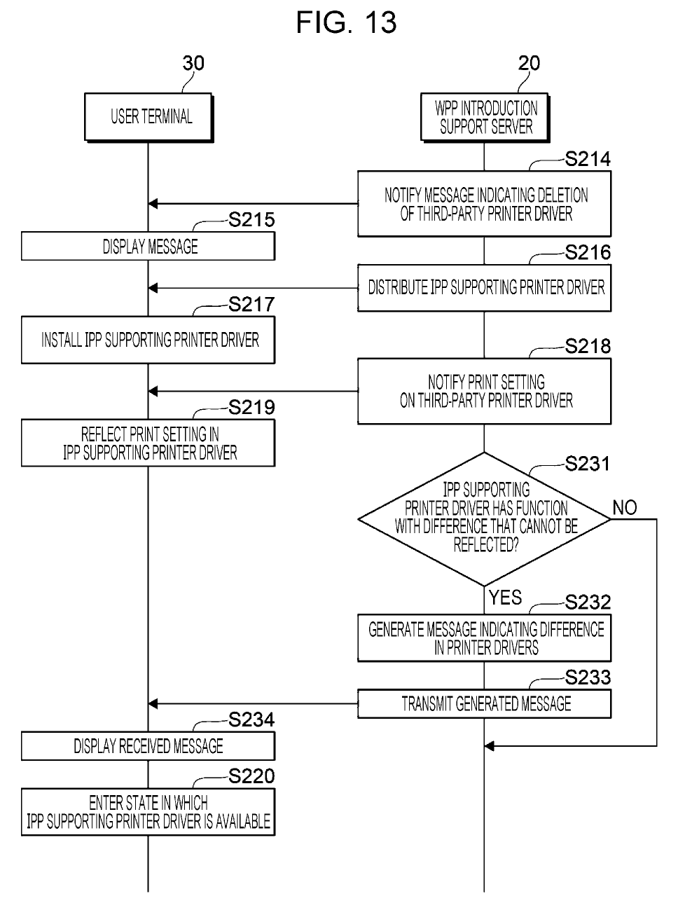

FIG. 13 is a diagram illustrating another processing sequence after an affirmative result is obtained in step 212 (see FIG. 9). In FIG. 13, parts corresponding to those in FIG. 10 are denoted by the same reference numerals.

Also in the case of the processing sequence illustrated in FIG. 13, the processing operations from step 214 to step 219 are the same as those in the first exemplary embodiment.

Still, in FIG. 13, the WPP introduction support server 20 that has executed step 218 determines whether the IPP supporting printer driver has a function with a difference that cannot be reflected (step 231).

For example, when the difference can be reflected in terms of specifications, a negative result is obtained in step 231. In this case, the WPP introduction support server 20 ends the current support operation without performing the processing described below. In this case, the same process as that of the first exemplary embodiment is executed.

On the other hand, when the difference cannot be reflected in terms of specifications, an affirmative result is obtained in step 231. This type of difference includes the setting related to the stapling function described above.

In this case, the WPP introduction support server 20 generates a message indicating the difference in the printer drivers (step 232).

Then, the WPP introduction support server 20 transmits the generated message to the user terminal 30 (step 233).

The user terminal 30 displays the received message (step 234). Then, the user terminal 30 enters a state in which the IPP supporting printer driver is available (step 220).

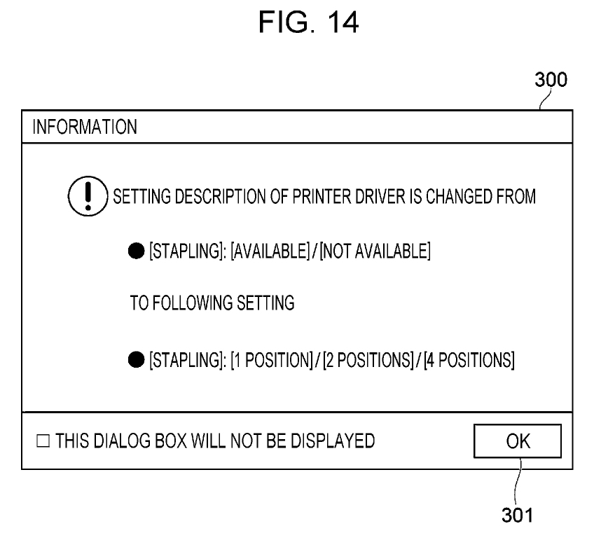

FIG. 14 is a diagram illustrating a display example of a message 300 for notifying a non-reflectable setting. The message 300 illustrated in FIG. 14 displays information on the above-described stapling function. More specifically, a change in the setting description of the printer driver from [STAPLING]: [AVAILABLE]/[NOT AVAILABLE] to [STAPLING]: [1 POSITION]/[2 POSITIONS]/[4 POSITIONS] is indicated.

When the message 300 is displayed, the user can be aware of the fact that there is a setting failed to be maintained.

In the present exemplary embodiment, when an "OK" button 301 is operated, the message 300 is closed. When the "OK" button 301 is operated, the setting screen for printing may be automatically opened. When the printing setting screen opens, the user can register a desired setting before forgetting the content of the notification.

### Summary

With the present exemplary embodiment, since the notification indicating that there is a setting that has been failed to be maintained is issued in advance, the user can be careful not to execute unintended printing when the printer 40 (see FIG. 1) executes printing.

Without the function of displaying the message 300, there is a possibility that printing is executed in a state including a non-reflectable setting. In this case, unintended printing is executed.

However, as described above, according to the present exemplary embodiment, since the content of the advance setting that cannot be reflected is notified, execution of unintended printing can be reduced.

### THIRD EXEMPLARY EMBODIMENT

In the aforementioned exemplary embodiment, it is assumed that the upload program 33B for printer driver information (see FIG. 4) is installed in the user terminal 30 (see FIG. 1).

In the present exemplary embodiment, a description is given on a case where the policy management server 10 (see FIG. 1) is provided with a function of distributing the upload program for printer driver information.

### Configuration of Group Policy Management System

Also in the present exemplary embodiment, the group policy management system 1 (see FIG. 1) is assumed.

### Hardware Configuration of Terminal

In the present exemplary embodiment, the hardware configuration of the policy management server 10 (see FIG. 1) is changed.

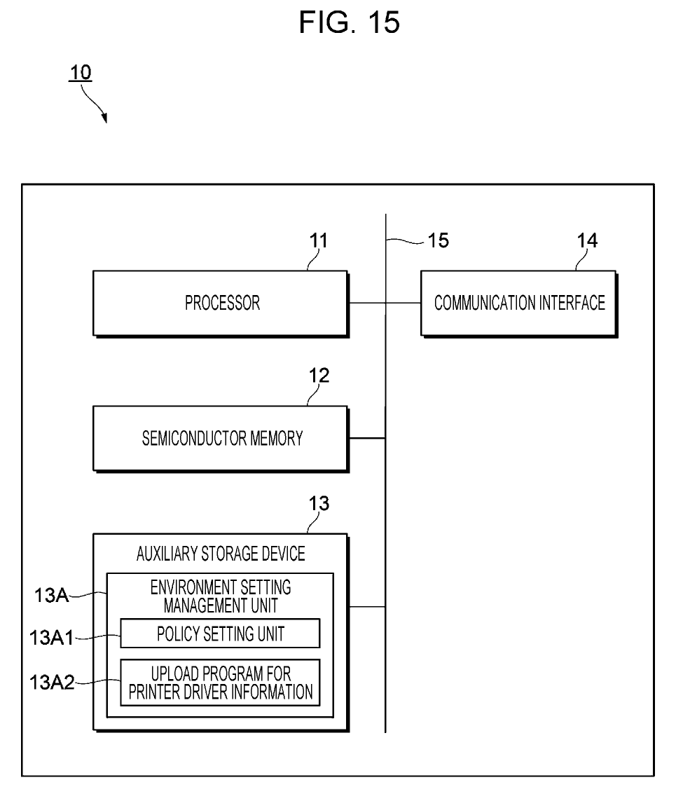

FIG. 15 is a diagram illustrating an example of a hardware configuration of the policy management server 10. In FIG. 15, parts corresponding to those in FIG. 2 are denoted by the same reference numerals.

In the case of the policy management server 10 illustrated in FIG. 15, a function of distributing an upload program 13A2 for printer driver information to the environment setting management unit 13A is added.

### Distribution Sequence for Upload Program

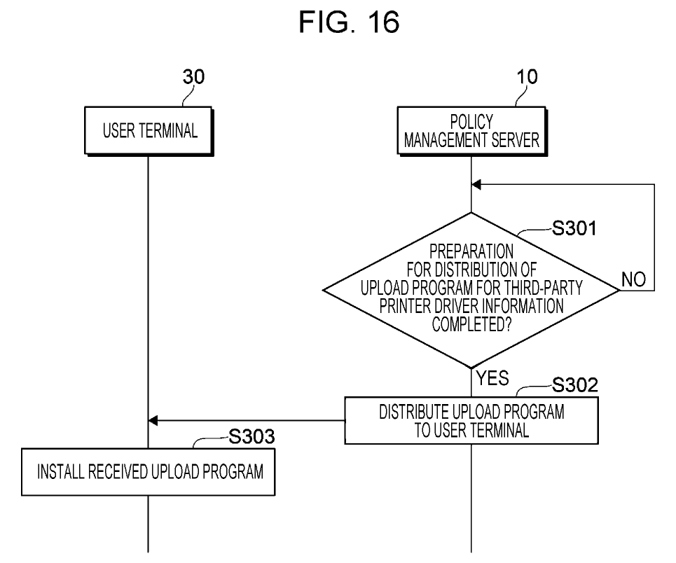

FIG. 16 illustrates an example of a distribution sequence for an upload program for printer driver information.

First, the policy management server 10 determines whether the preparation for distribution of an upload program for third-party printer driver information is completed (step 301).

When the activation of the WPP setting due to the application of the group policy is not scheduled, for example, a negative result is obtained in step 301. In this case, the policy management server 10 repeats the determination in step 301.

On the other hand, when the activation of the WPP setting due to the application of the group policy is scheduled and the distribution of the upload program is ready, an affirmative result is obtained in step 301.

In this case, the policy management server 10 distributes the upload program to the user terminal (step 302).

The user terminal 30 installs the received upload program (step 303).

### Summary

In the present exemplary embodiment, the policy management server 10, which manages the application of the group policy, is provided with the function of distributing the upload program for third-party printer driver information. Thus, the distribution of the upload program can be completed before the WPP setting is activated.

For example, before the WPP setting is activated, it may be determined whether the distribution of the upload program for third-party printer driver information has been completed, and the notification of the activation of the WPP setting may be controlled in accordance with the determination result.

For example, when the upload program is not distributed, the activation of the WPP setting may be suspended until the distribution is completed.

The policy management server 10 provided with a function of managing the completion of the installation of a distributed upload program, may also be provided with a function of suspending the activation of the WPP setting for the user terminals 30 before the completion of the installation.

### OTHER EXEMPLARY EMBODIMENTS

(1) Although the exemplary embodiments of the present disclosure have been described above, the technical scope of the present disclosure is not limited to the scope of the above-described exemplary embodiments. It is apparent from the claims that various changes in and improvements to the above-described exemplary embodiments are also included in the technical scope of the present disclosure.

(2) A case where the policy management server 10 (see FIG. 1) and the WPP introduction support server 20 (see FIG. 1) are different servers is described in the exemplary embodiments described above. However, these servers may be implemented as a single server.

(3) In the exemplary embodiments described above, each process is executed by any computer. Any computer may perform the processes by using a processor serving as hardware, a program serving as software, or a combination of these.

In this case, the processor is configured to perform various processes in the exemplary embodiments in cooperation with the program and may function as a unit or a means in the exemplary embodiments.

The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU).

Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor elements are combined, or the like.

Further, the program may be software such as firmware or microcode. The program may be, for example, a program module group, and the functions thereof may be implemented by processors configured to implement the respective functions. The program may be a program code or multiple code segments stored in one or more non-transitory computer readable media (such as, for example, a storage medium or another storage).

The program may be stored in such a divided manner in multiple non-transitory computer readable media present in apparatuses physically away from each other. The program code or the code segments may represent a procedure, a function, a sub program, a routine, a subroutine, a module, a software package, a class, or any combination of instructions, data structures, or program statements. The program code or the code segments may be connected to another code segment or a hardware circuit by transmitting and/or receiving information, data, an argument, a parameter, or memory content.

(4) The present disclosure can also be applied to a program and a program product.

### Appendix

### (((1)))

An information processing system comprising a processor configured to: store, as first information, information on a printer driver uploaded from a user terminal logging out from a server configured to manage a group policy; acquire, as second information, information on a printer driver uploaded from the user terminal logging into the server; and collate the first information with the second information and control distribution of a printer driver conforming to Windows Protected Print Mode to the user terminal.

### (((2)))

The information processing system according to (((1))), wherein the processor is configured to install, when the first information and the second information are different from each other, the printer driver conforming to Windows Protected Print Mode in the user terminal.

### (((3)))

The information processing system according to (((2))), wherein the processor is configured to reflect a setting of the first information in the printer driver installed in the user terminal.

### (((4)))

The information processing system according to (((2))), wherein the processor is configured to notify, when the first information is unable to be reflected in a specification of the printer driver conforming to Windows Protected Print Mode, the user terminal of a setting change.

### (((5)))

The information processing system according to (((2))), wherein the processor is configured to notify the user terminal of a difference in a third-party printer driver.

### (((6)))

The information processing system according to any one of (((1))) to (((5))), wherein a program for uploading the first information to a predetermined address is installed in the user terminal before setting of Windows Protected Print Mode is activated in the server.

### (((7)))

The information processing system according to (((6))), wherein the program is distributed from the server to the user terminal.

### (((8)))

A program causing a computer to execute functions comprising: storing, as first information, information on a printer driver uploaded from a user terminal logging out from a server configured to manage a group policy; acquiring, as second information, information on a printer driver uploaded from the user terminal logging into the server; and collating the first information with the second information and controlling distribution of a printer driver conforming to Windows Protected Print Mode to the user terminal.

What is claimed is:

1. An information processing system comprising a processor
the processor being configured to:
store, as first information, information on a printer driver uploaded from a user terminal logging out from a server configured to manage a group policy;
acquire, as second information, information on a printer driver uploaded from the user terminal logging into the server; and
collate the first information with the second information and control distribution of a printer driver conforming to Windows Protected Print Mode to the user terminal.

2. The information processing system according to claim 1, wherein the processor is configured to
install, when the first information and the second information are different from each other, the printer driver conforming to Windows Protected Print Mode in the user terminal.

3. The information processing system according to claim 2, wherein the processor is configured to
reflect a setting of the first information in the printer driver installed in the user terminal.

4. The information processing system according to claim 2, wherein the processor is configured to
notify, when the first information is unable to be reflected in a specification of the printer driver conforming to Windows Protected Print Mode, the user terminal of a setting change.

5. The information processing system according to claim 2, wherein the processor is configured to
notify the user terminal of a difference in a third-party printer driver.

6. The information processing system according to claim 1, wherein a program for uploading the first information to a predetermined address is installed in the user terminal before setting of Windows Protected Print Mode is activated in the server.

7. The information processing system according to claim 6, wherein the program is distributed from the server to the user terminal.

8. A non-transitory computer readable medium storing an information processing program causing a computer to execute functions comprising:
storing, as first information, information on a printer driver uploaded from a user terminal logging out from a server configured to manage a group policy;
acquiring, as second information, information on a printer driver uploaded from the user terminal logging into the server; and
collating the first information with the second information and controlling distribution of a printer driver conforming to Windows Protected Print Mode to the user terminal.
